(19) United States
(12) Patent Application Publication
(10) Pub. No.: US 2012/0223266 A1
(43) Pub. Date: Sep. 6, 2012

(54) ROLLING BEARING, THROTTLE VALVE DEVICE AND ABS DEVICE

(75) Inventor: Akimi FURUKOSHI, Kitasaku-gun (JP)

(73) Assignee: MINEBEA CO., LTD., Kitasaku-gun (JP)

(21) Appl. No.: 13/399,501

(22) Filed: Feb. 17, 2012

(30) Foreign Application Priority Data
Mar. 1, 2011 (JP) 2011-43922
Feb. 14, 2012 (JP) 2012-29699

(51) Int. Cl. F16C 33/78; F04B 17/03; F16K 1/22

(52) U.S. Cl. 251/305; 384/484; 417/410.1

(57) ABSTRACT

A rolling bearing having high sealing performance and a throttle valve device and an ABS device, which includes such rolling bearing. A metal core with a bent portion extending along a groove surface of the outer circumferential side of a V-shaped groove and an inner peripheral portion which extends in a radial direction beyond the deepest portion of the V-shaped groove toward a central axis from an inner circumferential side end of the bent portion, forms a gap in the radial direction within a region between an end of the inner peripheral portion of the metal core and an outer circumferential surface of an inner ring. The rigidity of an inner circumferential portion of the sealing member is ensured and a lip portion can be prevented from being rolled up by the external pressure.

### BACKGROUND OF THE INVENTION

1. Field of the Invention

The present invention relates to a rolling bearing having high sealing performance and also to a throttle valve device and an antilock brake system (ABS) device which include the rolling bearing.

2. Description of the Related Art

A structure where both ends of a throttle shaft are supported by a rolling bearing in a throttle valve device of an internal combustion engine is well known. The rolling bearing for such application is exposed to a severe pressure change and thus high sealing performance is required in the sealing structure which seals the annular space between the inner ring and outer ring. Japanese Patent Application Laid-Open (JP-A) No. 2004-263734 discloses a sealing structure where the annular space between the inner ring and outer ring is sealed by a pair of annular sealing members disposed to face each other in a central axis direction (particularly, refer to FIG. 6 of JP-A No. 2004-263734). In this sealing structure, if a pressure higher than the atmospheric pressure is applied to one of the pair of sealing members from the outside, a lip portion of the sealing member may be rolled up to the side of the annular space. As a result, the internal pressure of the annular space may increase and the other sealing member may be rolled up to the outside and may separate from the rolling bearing.

Therefore, to prevent such a problem, a rolling bearing is disclosed in the related arts wherein a step portion provided on an outer circumferential surface of the inner ring limits the movement of the lip portion even when a pressure higher than the atmospheric pressure is applied to the sealing member from the outside so as to move the lip portion toward the annular space (particularly, refer to FIG. 1 of JP-A No. 2004-263734). However, in the above rolling bearing, the step portion, i.e., the portion contacted by the lip portion, is usually finished by cutting process resulting in a surface accuracy inferior as compared with the surface accuracy finished by grinding process. For this reason, it is difficult to obtain high sealing performance at the step portion. In addition, grinding the step portion may increase the manufacturing cost because the finishing by low cost centerless grinding process cannot be performed to the step portion.

### SUMMARY OF THE INVENTION

Accordingly, the present invention has been made in view of the above circumstances and it is an object of the present invention to provide a rolling bearing having high sealing performance, which can be used under a situation where the external pressure received by a sealing member is high, and also to provide a throttle valve device and an ABS device which include such rolling bearing.

In order to achieve the above object, the present invention provides a rolling bearing having a seal structure in which an annular space between an inner ring and an outer ring is sealed by a pair of annular sealing members disposed to face each other in a central axis direction, wherein at least one of the pair of sealing members is composed of a metal core and an elastic member covering an external surface of the metal core, and includes an outer circumferential portion fitted into an inner circumferential surface of the outer ring, an inner circumferential portion provided with a lip portion contacting an outer circumferential surface of the inner ring, and an annular V-shaped groove formed in an outer portion of the inner circumferential portion configured by the elastic member, the V-shaped groove being placed around the central axis, and the metal core includes a bent portion extending along an annular groove surface at the outer circumferential side of the V-shaped groove and an inner peripheral portion extending radially beyond a deepest portion at the bottom of the V-shaped groove from an inner circumferential side end of the bent portion such that a gap is formed in a radial direction within a region between the inner peripheral portion and the outer circumferential surface of the inner ring.

In order to achieve the above object, a throttle valve device according to the present invention is a throttle valve device which includes the rolling bearing described in a first aspect of the present invention. A throttle shaft to which a throttle valve is fixed is supported by a throttle housing through the rolling bearing.

In order to achieve the above object, an antilock brake system (ABS) device according to the present invention is an ABS device which includes the rolling bearing described in a first aspect of the present invention. A driving shaft of an electric motor for driving an ABS pump is supported by a motor housing through the rolling bearing.

According to the present invention, a rolling bearing having high sealing performance suitable for use in a situation where the sealing member is subjected to a high external pressure, as well as a throttle valve device and an ABS device including such rolling bearing can be provided.

### BRIEF DESCRIPTION OF THE DRAWINGS

FIG. 1 is a cross-sectional view of a rolling bearing according to the first embodiment on an axial plane;

FIG. 2 is an explanatory view of the first embodiment showing the positional relationship between the inner circumferential portion of the sealing member with the lip portion in an undeformed condition and the outer circumferential surface of the inner ring;

FIG. 3 is a cross-sectional view of a rolling bearing (31) according to the related art on an axial plane;

FIG. 4 is a cross-sectional view of a rolling bearing (41) according to the related art on an axial plane;

FIG. 5 is a cross-sectional view of a rolling bearing (51) according to the related art on an axial plane;

FIG. 6 is a diagram illustrating the schematic configuration of the air leakage test device (negative pressure);

FIG. 7 is a diagram illustrating the schematic configuration of the air leakage test device (positive pressure);

FIG. 8 is a table summarizing the air leakage test results;

FIG. 9 is an explanatory view showing the state in which rolling up occurred in the sealing member of the rolling bearing of FIG. 4;

FIG. 10 is a cross-sectional view of the throttle valve device according to the second embodiment;

FIG. 11 is a detailed view of the portion A in FIG. 10; and

FIG. 12 is a cross-sectional view of the ABS device according to the third embodiment.

### DETAILED DESCRIPTION OF THE PREFERRED EMBODIMENTS

### First Embodiment

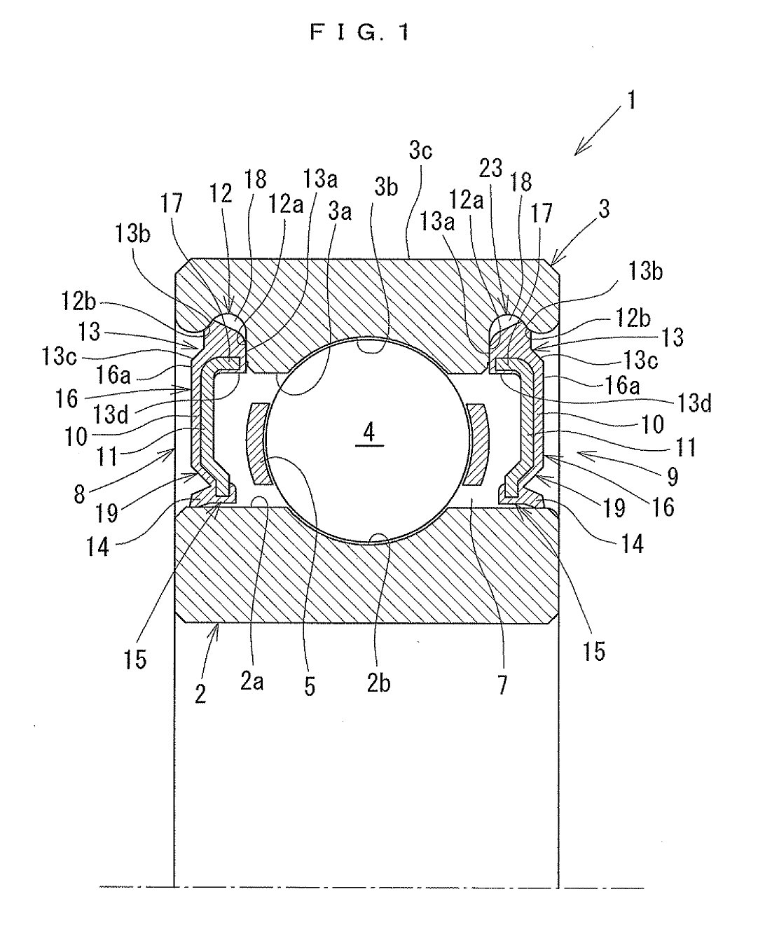

The first embodiment of the present invention will be described with reference to the accompanying drawings. In the following description, a central axis means the rotational axis (centerline) of a rolling bearing 1 which extends in a horizontal direction in FIG. 1, an axial plane means a plane which includes the central axis, and a transverse plane means a plane which is perpendicular to the central axis.

FIG. 1 is a cross-sectional view of the rolling bearing 1 according to the first embodiment on the axial plane. As illustrated in FIG. 1, the rolling bearing 1 includes an inner ring 2, an outer ring 3, a plurality of rolling elements 4 (steel balls) retained between an inner raceway 2b of the inner ring 2 and an outer raceway 3b of the outer ring 3, a retainer 5 which holds the rolling elements 4 at a predetermined interval on the raceways 2b and 3b, and a pair of sealing members 8 and 9 which are disposed to face each other in a central axis direction (horizontal direction in FIG. 1) and form an annular space 7 between the inner ring 2 and the outer ring 3.

The sealing member 8 is formed annularly along the annular space 7 and is obtained by integrating an elastic member 10 made of a rubber material such as nitrile rubber or the like with a metal core 11. As illustrated in FIG. 1, the sealing member 8 is disposed to be parallel to the transverse plane and includes an outer circumferential portion 13 which is fitted into an annular fitting groove 12 formed in an end of an inner circumferential surface 3a of the outer ring 3, an inner circumferential portion 15 which has a lip portion 14 contacting closely an outer circumferential surface 2a of the inner ring 2, and an intermediate portion 16 which is formed between the outer circumferential portion 13 and the inner circumferential portion 15. The elastic member 10 is formed to cover the external surface of the metal core 11.

The outer circumferential portion 13 of the sealing member 8 includes a first contact surface 13a which contacts a first sealing surface 12a of the fitting groove 12 parallel to the transverse plane, a corner portion 13b which contacts a second sealing surface 12b having an opening angle of about 45° to the first sealing surface 12a, an inclined surface 13c connecting the corner portion 13b to an external surface 16a of the intermediate portion 16, and a flange surface 13d disposed to be approximately flush with the inner circumferential surface 3a of the outer ring 3. The outer circumferential portion 13 is pressed to the fitting groove 12 by an annular flange portion 17 formed by bending an outer peripheral portion of the metal core 11 to the side of the annular space 7 at a right angle. As illustrated in FIG. 1, the flange portion 17 of the metal core 11 is covered with the elastic member 10. A predetermined annular space 18 is formed between the fitting groove 12 and the outer circumferential portion 13.

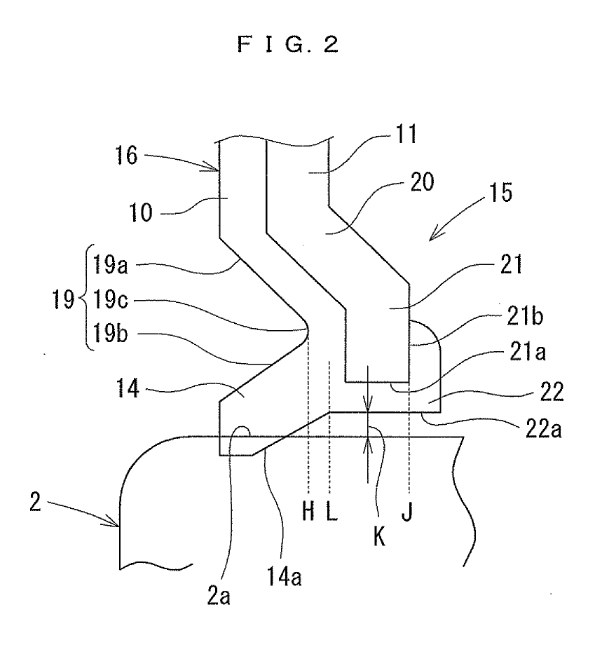

As illustrated in FIGS. 1 and 2, in the inner circumferential portion 15 of the sealing member 8, an annular V-shaped groove 19 having the central axis of bearing 1 as its center is formed on the outside surface of the elastic member 10. The V-shaped groove 19 includes an outer circumferential side groove surface 19a continuing to the external surface 16a of the intermediate portion 16 and an inner circumferential side groove surface 19b corresponding to the surface opposite to the surface 14a of lip portion 14 which contacts the outer circumferential surface 2a of the inner ring 2. The opening angle of V-shaped groove 19 is set to 90° or less. The metal core 11 has a bent portion 20 which is bent along the groove surface 19a from the inner circumferential side end of the intermediate portion 16 and an inner peripheral portion 21 extending in a radial direction beyond a deepest portion 19c at the bottom of the V-shaped groove 19 from the inner circumferential side end of the bent portion 20. As illustrated in FIG. 2, a gap having a constant dimension K in the radial direction (vertical direction in FIG. 2) is formed between an end face 21a of the inner peripheral portion 21 of the metal core 11 and the outer circumferential surface 2a of the inner ring 1

As illustrated in FIG. 2, the inner peripheral portion 21 of the metal core 11 is covered by an annular base portion 22 formed on the inner circumferential side of the elastic member 10. The annular base portion 22 has a surface 22a disposed between the outer circumferential surface 2a of the inner ring 2 and the end face 21a of the inner peripheral portion 21 of the metal core 11 and forms a gap K having a constant dimension in the radial direction between the outer circumferential surface 2a of the inner ring 2 and the surface 22a. The lip portion 14 extends from the base portion 22 to the outside and the inner circumferential side. The transverse plane L which includes the edge between the contact surface 14a of the lip portion 14 and the surface 22a of the base portion 22 is positioned at the axially inner side direction (right side in FIG. 2) to the transverse plane H including the deepest portion 19c of the V-shaped groove 19.

In the contact surface 14a of the lip portion 14 of first embodiment, the surface roughness is set such that the maximum height of roughness profile (Rz) is 6.0 μm or less and the arithmetic average roughness of roughness profile (Ra) is 1.3 μm or less. In the outer circumferential surface 2a of the inner ring 2 where the lip portion 14 is in close contact, the surface roughness is set such that the total height of primary profile (Pt) is set to 3.0 μm or less and the arithmetic average roughness (Ra) is set to 0.25 μm or less. As illustrated in FIG. 2, in the first embodiment, a gap K in the radial direction (vertical direction in FIG. 2) is formed between the elastic member 10 and the outer circumferential surface 2a of the inner ring 2, at least in a range between the transverse plane H (outer transverse plane) including the deepest portion 19c of the V-shaped groove 19 and the transverse plane J (inner transverse plane) including the inner surface 21b of the inner peripheral portion 21 of the metal core 11 (the axial interval between the planes H and J in FIG. 2). If the radial gap K is not formed in the range between the transverse plane H and the transverse plane J, a pressing force is generated between the outer circumferential surface 2a of the inner ring 2 and the surface 22a of the base portion 22 (seal), and the rotational torque of the rolling bearing 1 increases.

In FIG. 2, since the lip portion 14 is showed in undeformed condition, the front end of the lip portion 14 appears to interfere with the outer circumferential surface 2a of the inner ring 2. Actually, when the sealing member 8 is assembled, the lip portion 14 is pressed to the inner ring 2 and deforms elastically. As a result, a pressing force is generated between the inner ring 2 and the sealing member 8, so that the lip portion 14 comes in close contact with the inner ring 2, and high airtightness is obtained. In this case, if the V-shaped groove 19 is not provided in the sealing members 8 and 9 the rotational torque of the rolling bearing 1 may increase because the space for allowing the deformation of lip portion 14 disappears and consequently an excessive pressing force is generated.

The sealing member 9 in FIG. 1 has the same structure as that of the sealing member 8. Therefore the detailed description thereof will not be repeated. Also, since the structure of the rolling bearing 1 according to the first embodiment except the sealing members 8 and 9 is same to the related art, the detailed description of the same will not be repeated to simplify the description of the specification.

Next, the action of the first embodiment will be described.

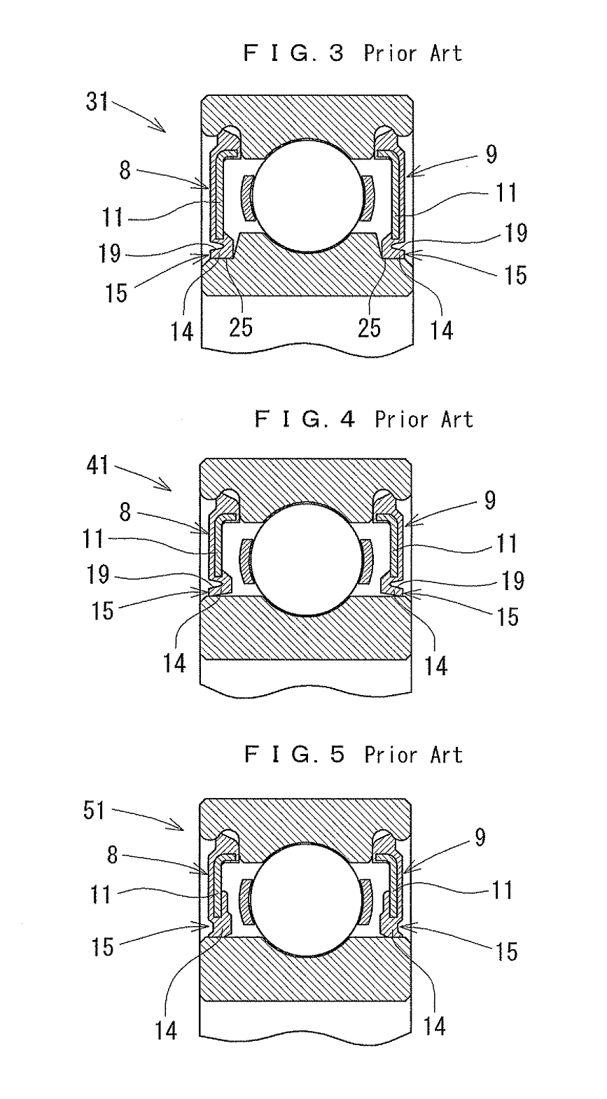

An air leakage test for the rolling bearing 1 according to the first embodiment illustrated in FIG. 1 was carried out as Example 1 by applying an external pressure (air pressure) to the sealing structure. In addition, the same air leakage test was carried out for the rolling bearings 31, 41, and 51 according to the related art illustrated in FIGS. 3, 4, and 5 as Comparative Examples 1, 2 and 3 respectively.

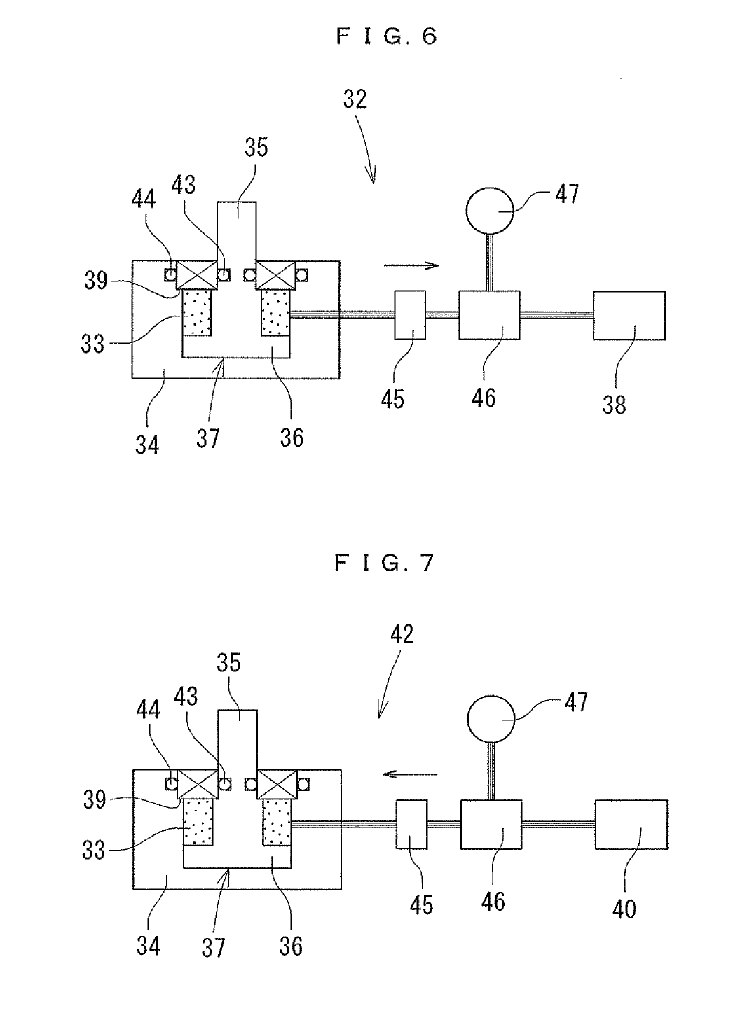

The rolling bearing 31 illustrated in FIG. 3 corresponds to FIG. 1 of JP-A No. 2004-263734 described above, the rolling bearing 41 illustrated in FIG. 4 corresponds to FIG. 6 of JP-A No. 2004-263734, and the rolling bearing 51 illustrated in FIG. 5 corresponds to FIG. 3 of JP-A No. 2004-263734. Therefore, the detailed description of the rolling bearings 31, 41, and 51 will be omitted. The components in the rolling bearings 31, 41, and 51 correspondent to those of the rolling bearing I will be referred with the same names and reference numerals as those of the rolling bearing 1 illustrated in FIG. 1.

The surface roughness of each of the rubber seal lip portions 14 and the outer circumferential surfaces 2a of the inner rings 2 according to Example 1 and Comparative Examples 1 to 3 are illustrated in Table 1. For each example, three samples were measured and tested.

In Table 1, the total height of primary profile (Pt), the arithmetic average roughness of roughness profile (Ra), and the maximum height of roughness profile (Rz) are based on JIS B 0601: 2001.

TABLE 1

| | |
|---|---|
| | Surface |
| | roughness |
| | of the outer |
| Surface | circumferential |
| roughness | surface of |
| of the lip | the inner |
| portion (μm) | ring (μm) |

| Sample | No. | Rz | Ra | Pt | Ra |
|---|---|---|---|---|---|
| Example 1 | 1 | 6.0 | 1.3 | 3.0 | 0.25 |
| | 2 | 3.6 | 0.73 | 1.8 | 0.16 |
| | 3 | 2.3 | 0.31 | 1.3 | 0.11 |
| Comparative | 1 | 14 | 3.5 | 5.0 | 0.50 |
| Example 1 | 2 | 9.9 | 2.4 | 4.2 | 0.44 |
| | 3 | 8.3 | 1.6 | 3.4 | 0.35 |
| Comparative | 1 | 12 | 3.3 | 3.0 | 0.25 |
| Example 2 | 2 | 9.3 | 2.0 | 1.8 | 0.16 |
| | 3 | 7.8 | 1.7 | 1.3 | 0.11 |
| Comparative | 1 | 12 | 3.2 | 3.0 | 0.25 |
| Example 3 | 2 | 9.7 | 2.4 | 1.8 | 0.16 |
| | 3 | 8.4 | 1.8 | 1.3 | 0.11 |

FIGS. 6 and 7 are diagrams illustrating the schematic configurations of test devices 32 and 42 used for the air leakage tests. The test device 32 in FIG. 6 includes a housing 34 having a cylindrical pressure chamber 33, a jig 37 which includes a shaft 35 fitted into the inner circumferential surface of the inner ring 2 and a flange 36 provided in a lower end of the shaft 35 and slidably fitted into the bottom of the pressure chamber 33, and a pressure reduction pump 38 which supplies the negative pressure to the pressure chamber 33. In the test device 32, the outer circumferential surfaces 3a of the outer rings 3 of the rolling bearings 1, 31, 41, and 51 which are the test objects are fitted into an annular step portion 39 formed in the opening (upper portion of the pressure chamber 33) of the housing 34.

In FIG. 6, reference numerals 43 and 44 denote O-rings, reference numeral 45 denotes a flowmeter, reference numeral 46 denotes a regulator, and reference numeral 47 denotes a pressure meter. The test device 42 illustrated in FIG. 7 has the configuration in which the pressure reduction pump 38 of the test device 32 in FIG. 6 is replaced by a pressure pump 40. With respect to the sliding torque of each of the rolling bearings 1, 31, 41, and 51, it was evaluated based on the sliding torque measured when the shaft 35 was rotated around its rotational axis relatively to the housing 34.

The first to fourth conditions of the air leakage test are described below.

(First Condition)

In the first condition, airtight performance (sealing performance) and the sliding torque of each of the rolling bearings 1, 31, 41, and 51 when the pressure of the pressure chamber 33 is varied from −60 to +129 kPa were measured. In the first condition, test of the airtight performance was considered approved when the airtight performance was 100 mL/min or less and the test of the airtight performance was considered failed when the airtight performance was more than 100 mL/min.

(Second Condition)

In the second condition, airtight performance and the sliding torque of each of the rolling bearings 1, 31, 41, and 51 when the pressure of the pressure chamber 33 is varied from −60 to +129 kPa were measured. In the second condition, the test of the airtight performance was considered approved when the airtight performance is 0.5 mL/min or less and the test of the airtight performance was considered failed when the airtight performance was more than 0.5 mL/min.

(Third Condition)

In the third condition, airtight performance and the sliding torque of each of the rolling bearings 1, 31, 41, and 51 when the pressure of the pressure chamber 33 is varied from +130 to +235 kPa were measured. In the third condition, the test of the airtight performance was considered approved when the airtight performance is 0.5 mL/min or less and the test of the airtight performance was considered failed when the airtight performance was more than 0.5 mL/min.

(Fourth Condition)

In the fourth condition, airtight performance and the sliding torque of each of the rolling bearings 1, 31, 41, and 51 when the pressure of the pressure chamber 33 is varied from −70 to +300 kPa were measured. In the fourth condition, the test of the airtight performance was considered approved when the airtight performance is 0.5 mL/min or less and the test of the airtight performance was considered failed when the airtight performance was more than 0.5 mL/min.

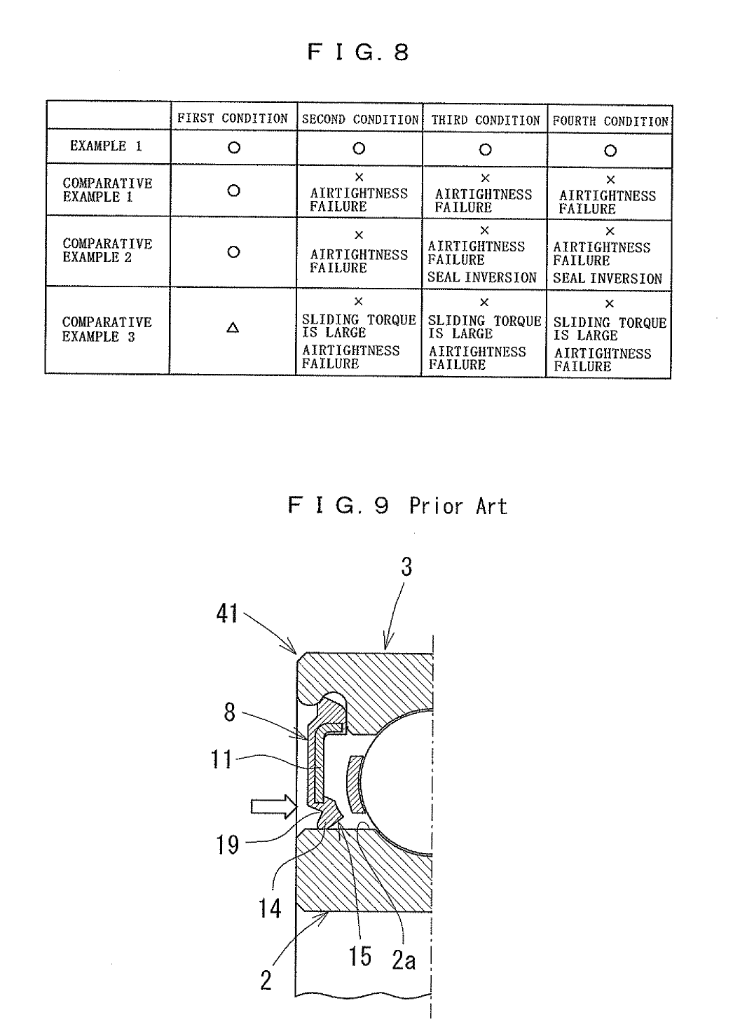

FIG. 8 summarizes the test results of the air leakage tests carried out under the first to fourth conditions. In the table shown in FIG. 8, ∘ indicates success in the test, ×indicates failure, and, Δ indicates that the airtight performance was approved but the sliding torque failed (excessively large).

(First Condition)

During the test under the first condition, all of the rolling bearings 1, 31, 41, and 51 showed the airtight performance (sealing performance) of 100 mL/min or less. However, with respect to the rolling bearing 51, the sliding torque was excessively large. It is likely that the sliding torque was excessively large because the V-shaped groove 19 was not provided in the sealing members 8 and 9 of the rolling bearing 51 as in, the rolling bearings 1, 31, and 41, and the inner circumferential portions 15 of the sealing members 8 and 9 were pressed to the outer circumferential surface of the inner ring 2 by the metal core 11 with the excessive force.

(Second Condition)

During the test under the second condition, the rolling bearing 31 in FIG. 3, the rolling bearing 41 in FIG. 4, and the rolling bearing 51 in FIG. 5 did not satisfy the airtight performance of 0.5 mL/min or less. In the rolling bearing 31, the step portion 25 of the inner ring 2 where the lip portion 14 contacts could not be finished by centerless grinding and alternatively it was finished by cutting. Consequently, the surface accuracy of step portion 25 was lowered in comparison to the surface accuracy of a surface finished by centerless grinding. In addition, the contact surface of the lip portion 14 did not satisfy the conditions corresponding to the maximum height (Rz) of 6.0 μm or less and the arithmetic average roughness (Ra) of 1.3 μm or less. Due to these two factors, the sufficient adhesion force of the lip portion 14 was not obtained. With respect to the rolling bearings 41 and 51, the contact surface of the lip portion 14 did not satisfy the conditions where the maximum height (Rz) is 6.0 μm or less and the arithmetic average roughness (Ra) is 1.3 μm or less. Therefore, the sufficient adhesion force of the lip portion 14 was not obtained.

(Third Condition)

During the test under the third condition, only the rolling bearing 1 according to the first embodiment satisfied the airtight performance of 0.5 mL/min or less. In the rolling bearing 1, since the inner circumferential side end of the metal core 11 extends in a radial direction beyond the deepest portion 19c of the V-shaped groove 19, the inner circumferential portion 15 of the sealing member 8 has sufficient rigidity and the inner circumferential portion 15 is not rolled up to the low pressure side (inner side of the bearing). In the sealing member 8 of the rolling bearing 41, rolling up (seal inversion) as showed in FIG. 9 was verified. The rigidity of the inner circumferential portion 15 of the sealing member 8 was insufficient because the inner circumferential side end of the metal core 11 does not extend in the radial direction beyond the deepest portion 19c of the V-shaped groove 19, i.e., the diameter of the inner circumferential side end of the metal core 11 is larger than the diameter of the V-shaped groove 19 and, without the step portion 25 in the inner ring 2, the inner circumferential portion 15 of the sealing member 8 was rolled up to the low pressure side.

(Fourth Condition)

During the test under the fourth condition, only the rolling bearing 1 satisfied the airtight performance of 0.5 mL/min or less. In the rolling bearing 1, since the inner peripheral portion 21 of the metal core 11 extends beyond the deepest portion 19c of the V-shaped groove 19 in the radial direction, the rigidity of the inner circumferential portion 15 of the sealing member 8 is sufficient and the inner circumferential portion 15 of the sealing member 8 is not rolled up to the low pressure side (inner side of the bearing). However, in the sealing member 8 of the rolling bearing 41, rolling up (seal inversion) as illustrated in FIG. 9 was verified. The rigidity of the inner circumferential portion 15 of the sealing member 8 was insufficient because the inner peripheral portion of the metal core 11 does not extend beyond the deepest portion 19c of the V-shaped groove 19 in the radial direction, i.e., the diameter of the inner peripheral portion of the metal core 11 was larger than the diameter of the V-shaped groove 19 and, without the step portion 25 in the inner ring 2, the inner circumferential portion 15 of the sealing member 8 was rolled up to the low pressure side. In the rolling bearing 51, rolling up (seal inversion) of the sealing member 8 was not verified. However, since the contact surface of the lip portion 14 did not satisfy the conditions where the maximum height (Rz) is 6.0 μm or less and the arithmetic average roughness (Ra) is 1.3 μm or less, the sufficient adhesion force of the lip portion 14 was not obtained. In the rolling bearing 31, the surface finishing by centerless grinding could not be performed to the step portion 25 of the inner ring 2 where the lip portion 14 contacts and the surface was finished by cutting. Since the surface accuracy was lowered in comparison to the surface accuracy of a surface finished by centerless grinding, the contact surface of the lip portion 14 did not satisfy the conditions where the maximum height (Rz) is 6.0 μm or less and the arithmetic average roughness (Ra) is 1.3 μm or less. Therefore, the sufficient adhesion force of the lip portion 14 was not obtained.

In the first embodiment, the following effects can be achieved.

According to the first embodiment, the metal core 11 is provided with the bent portion 20 which extends along the groove surface 19a of the outer circumferential side of the V-shaped groove 19 and the inner peripheral portion 21 which extends from the inner circumferential side end of the bent portion 20 beyond the deepest portion 19c of the V-shaped groove 19 toward the central axis, such that the end face 21a of the inner peripheral portion 21 has a gap in the radial direction to the outer circumferential surface 2a of the inner ring 2.

Therefore, the rigidity of the inner circumferential portions 15 of the sealing members 8 and 9 is obtained and the lip portion 14 can be effectively prevented from being rolled up by the external pressure.

In addition, in the contact surface 14a of the lip portion 14, the maximum height (Rz) is set to 6.0 μm or less and the arithmetic average roughness (Ra) is set to 1.3 μm or less, and in the surface (outer circumferential surface 2a) of the lip portion 14 which the inner ring 2 is contacting closely, the total height of primary profile (Pt) is set to 3.0 μm or less and the arithmetic average roughness (Ra) is set to 0.25 μm or less. The gap in the radial direction is formed between the elastic member 10 and the outer circumferential surface 2a of the inner ring 2, at least in a range between the outer transverse plane including the deepest portion 19c of the V-shaped groove 19 and the inner transverse plane including the inner surface 21h of the inner peripheral portion 21 of the metal core 11 (between planes H and J in the axial direction), and the escape space for the deformed lip portion 14 is formed by providing the V-shaped groove 19 in the sealing members 8 and 9. Therefore, the appropriate sliding torque can be obtained while the airtight performance (sealing performance) of the sealing structure is ensured.

The outer circumferential surface 2a of the inner ring 2 where the lip portions 14 of the sealing members 8 and 9 are in close contact is a cylindrical surface of constant diameter extending continuously to the raceway of the inner ring, i.e., the outer circumferential surface 2a of the inner ring 2 does not have the step portion 25 as in the rolling bearing 31 illustrated in FIG. 3. For this reason, the finishing by the centerless grinding can be performed on the portion where the lip portion 14 of the inner ring 2 contacts. Therefore, manufacturing costs can be reduced in comparison with the finishing by cutting operation performed on the step portion 25. Since the surface accuracy of the grinding finishing surface is higher than the surface accuracy of the cutting finishing surface, the required airtight performance (sealing performance) can be ensured. The airtight performance can be also ensured by mounting the sealing member 8 only on the side where the pressure difference with the internal space of the rolling bearing 1 is generated, and mounting a conventional sealing member on the other side.

### Second Embodiment

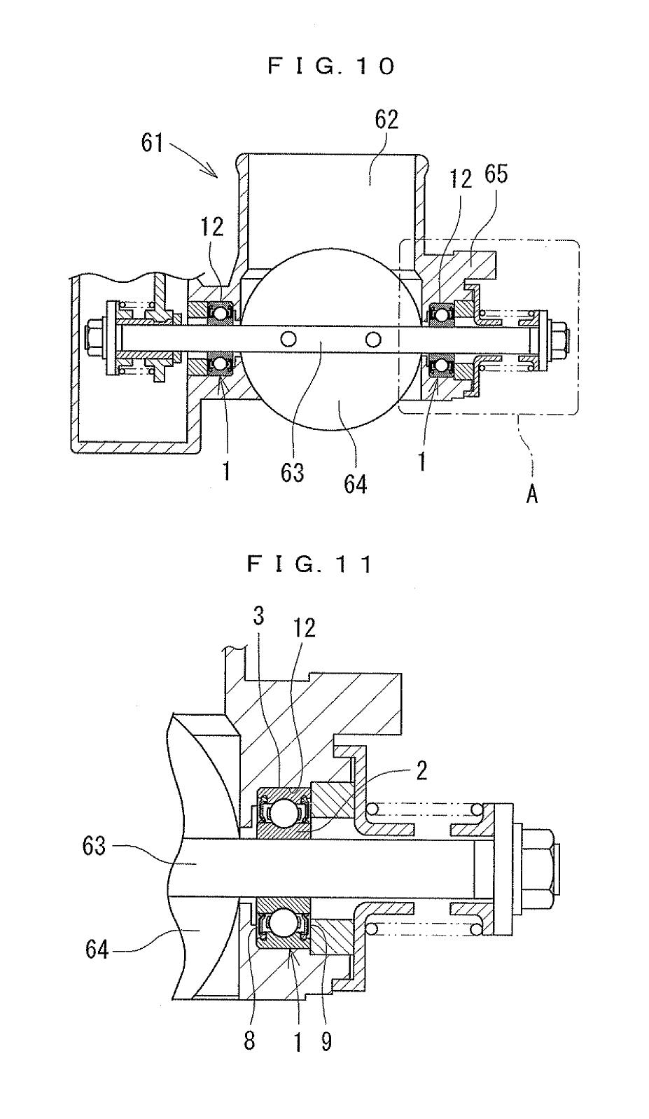

The second embodiment of the present invention will be described with reference to the accompanying drawings. FIGS. 10 and 11 illustrate an embodiment where the rolling bearing 1 according to the first embodiment is applied to a throttle valve device 61 of an internal combustion engine. The same names and reference numerals are given to the same components as those of the first embodiment.

In the throttle valve device 61, a throttle valve 64 is fixed to a throttle shaft 63 passing through an air intake passage 62 in a diameter direction (horizontal direction in FIG. 10) and both ends of the throttle shaft 63 are supported by the rolling bearing 1. The outer ring 3 of each rolling bearing 1 is fitted into a fitting groove 12 of a housing 65. Since the configuration other than the rolling bearing 1 is the same as that of a conventional throttle valve device, the detailed description of the throttle valve device 61 will not be repeated in order to simplify the description of the specification.

Next, the action of the second embodiment will be described.

With respect to the throttle valve device 61, the internal pressure in the air intake passage 62 frequently changes during the movement of vehicle (when the internal combustion engine is operated). Thereby, the sealing member of the rolling bearing 1 according to the first embodiment mounted at the side of the air intake passage 62 (sealing member 8 illustrated in FIG. 11) is subjected to a pressure variation which can be a positive pressure or a negative pressure depending on the engine configuration. For this reason, when a positive pressure is applied to the sealing member 8, the lip portion 14 is pressed strongly to the outer circumferential surface 2a of the inner ring 2. As a result, sliding resistance between the lip portion 14 and the outer circumferential surface 2a of the inner ring 2 increases and rotational resistance of the rolling bearing 1 also increases according to the sliding resistance. In addition, when a high positive pressure is applied to the sealing member 8, the inner circumferential portion 15 of the sealing member 8 may be inverted to the inner side and may be rolled up. As a result, sealing performance of the sealing structure is deteriorated (refer to FIG. 9).

When a high negative pressure is applied to the sealing member 9 of the side opposite to the air intake passage 62, the inner circumferential portion 15 of the sealing member 9 may be inverted to the inner side of the rolling bearing 1 and may be rolled up. As a result, sealing performance of the sealing structure is deteriorated.

In the second embodiment, the required airtight performance (sealing performance) is ensured by supporting both ends of the throttle shaft 63 with the rolling bearing 1 according to the first embodiment, even when either a positive pressure or a negative pressure is applied to the sealing structure. In addition, the throttle valve device 61 suitable for use in a severe environment where the pressure difference between the air intake passage 62 and the annular space 7 of the rolling bearing 1 is in the range of −70 kPa to +300 kPa can be provided. In the second embodiment, the airtight performance can also be achieved by mounting a sealing member according to the present invention only on the side opposite to the air intake passage 62 and a conventional sealing member on the other side, instead of mounting the sealing members according to the present invention on both sides of the rolling bearing 1.

### Third Embodiment

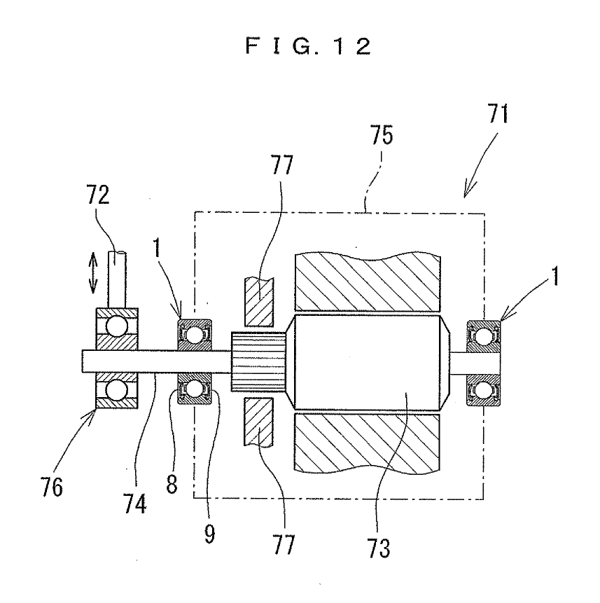

The third embodiment of the present invention will be described with reference to the accompanying drawings. FIG. 12 illustrates an embodiment where the rolling bearing 1 according to the first embodiment is applied to an ABS device 71 of a vehicle. The same components as those of the first embodiment will be referred with the same names and reference numerals as in the first embodiment.

The ABS device 71 includes a piston 72 which pumps a brake fluid in a reservoir tank and supplies the brake fluid to a master cylinder of the brake system and an electric motor 73 which moves the piston 72 for driving the ABS pump. A driving shaft 74 of the electric motor 73 is supported by a pair of rolling bearings 1 mounted to a motor housing 75. Since the configuration of the ABS device 71 is the same as that of a conventional ABS device except the rolling bearing 1, the detailed description of the ABS device 71 will be omitted in order to simplify the description.

Next, the action of the third embodiment will be described.

As illustrated in FIG. 12, the electric motor 73 with the driving shaft 74 is mounted in a closed motor housing 75. The driving shaft 74 extends to the piston 72 side (left side in FIG. 12) and in its extremity an eccentric rolling bearing 76 is assembled for creating a reciprocating motion of the piston 72 in the vertical direction of FIG. 12. Therefore, when the brake fluid leaks at the side of the piston 72, the sealing structure of the rolling bearing 1 disposed on the piston 72 side is exposed to the leaked brake fluid.

In this situation, if liquid-tight performance (sealing performance) of the sealing structure of the rolling bearing 1 disposed on the piston 72 side is insufficient, the leaked brake fluid may infiltrate into the motor housing 75 through the rolling bearing 1. In addition, if the brake fluid infiltrated into the motor housing 75 reaches the brush 77 of the electric motor 73, the electric motor 73 may suffer an operation failure.

In the third embodiment, by supporting the driving shaft 74 of the electric motor 73 with the rolling bearing 1 according to the first embodiment, the infiltration of the leaked brake fluid into the motor housing 75 from the side of the piston 72 can be prevented, even when the brake fluid leaks at the side of the piston 72. Thereby, occurrence of failures of the electric motor 73 and the ABS device can be prevented in advance and the ABS device with high reliability can be provided. The above advantage can also be achieved even when the rolling bearing 1 according to the first embodiment is provided only at the piston 72 side (left side in FIG. 12) of the driving shaft 74. In addition, it is possible to configure only the sealing member at the piston 72 side as the sealing member 8 of the first embodiment.

It should be understood by those skilled in the art that the embodiments are not limited to the above described configurations and various changes and modifications may be made without departing from the spirit of the invention and the scope of the appended claims.

For example, although the rolling bearing 1 in foregoing description is a ball bearing, the sealing structure of the present invention can be applied to a roller bearing as well.

What is claimed is:

1. A rolling bearing having a sealing structure in which an annular space between an inner ring and an outer ring is sealed by a pair of annular sealing members disposed to face each other in a central axis direction,
wherein at least one of the pair of sealing members is composed of a metal core and an elastic member covering an external surface of the metal core, and includes an inner circumferential portion provided with a lip portion contacting an outer circumferential surface of the inner ring and an annular V-shaped groove formed around the central axis in an outer portion of the inner circumferential portion configured by the elastic member, and
the metal core includes a bent portion extending along an annular groove surface at the outer circumferential side of the V-shaped groove and an inner peripheral portion extending radially beyond a deepest portion of the V-shaped groove from an inner circumferential side end of the bent portion, such that a gap is formed in a radial direction within a region between an end face of the inner peripheral portion and the outer circumferential surface of the inner ring.

2. The rolling bearing according to claim 1,
wherein the outer circumferential surface of the inner ring includes cylindrical surfaces of constant diameter extending to the sealing members from both sides of a raceway surface of the inner ring.

3. The rolling bearing according to claim 1,
wherein, the surface roughness of a surface of the lip portion which contacts the outer circumferential surface of the inner ring is set such that the maximum height (Rz) of roughness profile is 6.0 μm or less and the arithmetic average roughness (Ra) is 1.3 μm or less, and
the surface roughness of at least a portion of the outer circumferential surface of the inner ring which is contacted by the surface of the lip portion is set such that the total height of primary profile (Pt) is 3.0 μm or less and the arithmetic average roughness (Ra) is 0.25 μm or less.

4. The rolling bearing according to claim 1,
wherein the gap is formed in a range at least between a plane perpendicular to the central axis including the deepest portion of the V-shaped groove, and a plane perpendicular to the central axis including an inner surface of the inner peripheral portion of the metal core.

5. A throttle valve device of an internal combustion engine including
a throttle valve fixed to a throttle shaft supported by a throttle housing through the rolling bearing according to claim 1.

6. An antilock brake system (ABS) device of a vehicle including an electric motor for driving an ABS pump provided with a driving shaft wherein
the driving shaft is supported by a motor housing through the rolling bearing according to claim 1.
